(19) United States
(12) Patent Application Publication
(10) Pub. No.: US 2009/0152197 A1
(43) Pub. Date: Jun. 18, 2009

(54) System for Energy Recovery and Reduction of Deposits on the Membrane Surfaces in (Variable Power and Variable Production) Reverse Osmosis Desalination Systems

(76) Inventors: Theodoros Lilas, Papagou (GR); Evanthia Antoniou, Peristeri (GR); Athanasios Vatistas, Peiraeus (GR); Konstantina Lila, Papagou (GR); Artemis Maglara, Zografou (GR); Christos Syrseloudis, Zografou (GR)

Correspondence Address: COOPER & DUNHAM, LLP, 30 Rockefeller Plaza, 20th Floor, NEW YORK, NY, 10112, US

(21) Appl. No.: 12/224,360

(22) PCT Filed: Feb. 26, 2007
(86) PCT No.: PCT/GR2007/000012

§ 371 Date: Nov. 20, 2008

(30) Foreign Application Priority Data
Feb. 24, 2006 (GR) 20060100122

(51) Int. Cl. B01D 65/02; B01D 29/66

(52) U.S. Cl. 210/636; 210/191

(57) ABSTRACT

A method and a device for desalination, that operates with reverse osmosis membranes (7) and pressure vessels (9) and (20) that are connected to the high pressure circuit via valves (17) and with the low pressure circuit via valves (10). The proposed system includes the operation of a water intake pump (2) and high pressure pump (5) and a circulating pump, when vessel (9) is connected to the high pressure circuit, vessel (20) is fed with fresh salty water in the low pressure, next vessel (20) is connected to the high pressure, vessel (9) is disconnected, then vessel (9) is rinsed, vessel (9) becomes complete with salty water in the low pressure, then vessel (9) is connected in the high pressure, next vessel (20) disconnected, vessel (20) is rinsed, vessel (20) becomes complete with fresh salty water in the low pressure. The process is repeated with alternation of vessels (9) and (20).

The proposed method doesn't have loses due to the exchange of the medium, as in other energy recovery systems, such as turbines or other pumps having efficiency smaller than one. In addition the circulation speed and flow is increased. Because of the high circulation and flow the concentration polarization is reduced. Which means that the effect of local increase in the concentration, near the surface of the membrane, is reduced and therefore the efficiency of the membranes is improved and the deposits decrease.

Additional optimizing can be accomplished: a) with the use of a mechanism based on the Bernoulli's Principle under conditions of pressure so as to avoid the use of a high pressure circulator with ultimate goal the reduction of cost and b) by using a centrifugal separator for the removal of solids and part of the organisms that exist in the water, before entering the membranes, so as to avoid the chemical processing of the water before entering the membranes and to avoid deposits on the membranes.

The application of our method and system to units having varying power supply or varying water production (powered by renewable energy sources) and in applications where there are high concentrations of dissolved substances and therefore required higher pressures to overcome the osmotic pressure, such as the desalination of sea water, processing of organic dilutions and waste water processing.

The invention concerns methods and devices for energy reduction during the operation of sea water desalination systems based on reverse osmosis. It also concerns the application of this method to desalination units that operate either with varying available power supply or varying water production. It concerns also applications were there is high concentration of dissolved substances and higher pressure is required to overcome the osmotic pressure. For example, like in the case of desalinating sea water, processing of organic dilutions and waste water processing.

Desalination units based on the method of reverse osmosis are the majority of desalination apparatus used in practice. The reverse osmosis desalination systems use a high pressure pump and feed the water, being processed, through a semi-permeable membrane where only pure water molecules pass through, while the larger molecules like dissolved salts or other foreign materials, within the water, cannot pass through the membranes and remain. Finally they are disposed off along with the remaining raw water. The semi-permeable membrane is placed inside a container usually having cylindrical shape. The container has two outputs, one for pure (clean) water and one for high pressure, high concentration of salts, water (brine). The increased (high) energy consumption of the reverse osmosis system is related to the increase of the water pressure that is required at the input of the membranes unit. This water has to pass through the membranes and therefore needs to overcome the osmotic pressure.

Main problem that concerns the designers and manufactures of desalination units is energy consumption and deposition of various substances on membranes surface, which result in reduction of pure water production capacity of the unit. Many different systems have already been proposed for reduction of energy consumption. Such systems are: (a) Pressure exchange vessels (b) turbines (c) pumps (d) rotating tubes. The classic pressure exchange vessels use an actual or a virtual piston. Usually they are oblong like tubes and at one end enters the salty water under high pressure (the exit of the brine from the reverse osmosis system). The “piston” moves towards the other end of the tube reducing the volume of the corresponding compartment in which there is water we want to feed into the reverse osmosis system. The reduction of available volume increases pressure and therefore we don't consume a lot of energy to get this water (in the inlet) to the required higher pressure. The high pressurized water on the one side in case of an actual piston does not mix with the new amount of water we want to feed to the inlet of the reverse osmosis system. The transmission of energy for the increase of pressure of new water at the inlet is accomplished via the piston mechanism that results in energy loss due to friction. Then the piston returns to its original position. These systems require complicated mechanisms that increase the cost and cause problems during their operation under conditions of varying water supply. The reason is that they are adjusted for optimized operation in a small range of pressure and water supply and if this range changes then they need to be modified or readjusted.

In case that we need variable water production, either because of varying water consumption or varying power supply (eg. when we have renewable energy sources), existing systems exhibit major problems. In summary the problems are: (a) either the membranes are supplied with the same flow but with a lower pressure resulting in increased energy consumption per unit of produced water, which increases cost, because the preprocessed water is just disposed, (b) or water flow is reduced thus increasing deposit problems (c) or we have intermittent operation, which requires more cleaning operations and so the cost of produced water increases.

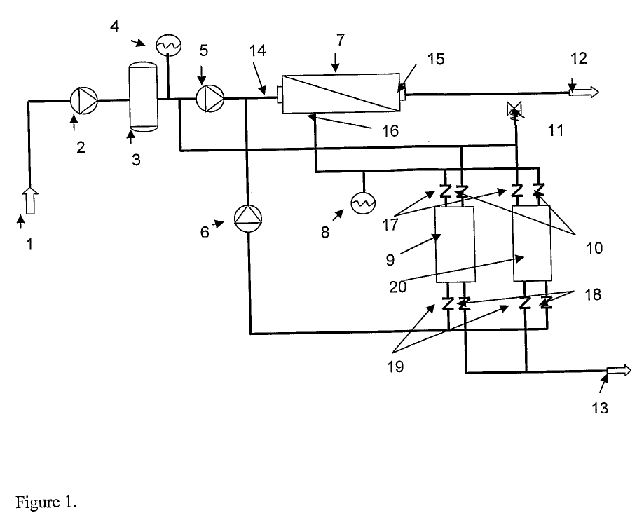

In the invention presented, the proposed system is based on pressure exchange vessels (as in (a)), but operate in a different way. The system consists of the following parts, as shown in FIG. 1: the salty water inlet (1), safety devices (11), low pressure salty water intake pump (2), the pre-filter unit (3), high pressure pump (5), reverse osmosis semi-permeable membranes (7), at least two pressure vessels (9), (20), the water circulation pump for the high pressure circuit (6), the water flow regulation valves (10), (17), (18), (19), an optional pressure stabilizer (8), permeate water output (12), high salinity water output (13).

Briefly the operation is based on at least two high pressure vessels (9) and (20), in which salty water circulates. The output of salty water (brine) from the reverse osmosis unit is at high pressure. To take advantage of this energy, instead of dumping brine in the sea it is guided into one of the high pressure vessels that supplies the input of the reverse osmosis unit. The intake of water into the reverse osmosis unit is added with the flow of water from the high pressure vessel. In this way we succeed in passing more water (that is under high pressure) to the membranes without needing additional energy. The result is also more water passing through the membranes (increase in efficiency) and due to increased flow, the deposits on the membranes decrease. The salinity increases gradually in the high pressure circuit. When it becomes to high then the two pressure vessels are exchanged in the circuit, so that the second (20) operates, while the first (9) is flushed with water from the low pressure circuit (using the valves (17)). The process is repeated with the interchange of the vessels (9) and (20). Almost all the amount of water that is supplied by the pressure pump becomes desalinated water.

The invention is described below with the help of an example and references to the attached FIG. 1 in which the system parts are depicted. The system consists of the following parts: the salty water inlet (1), safety devices (11), low pressure salty water intake pump (2), pre-filter unit (3), high pressure pump (5), reverse osmosis semi-permeable membranes (7), at least two pressure vessels (9), (20), water circulation pump for the high pressure circuit (6), water flow regulation valves (10), (17), (18), (19), optional pressure stabilizers (4) and (8), permeate water output (12), high salinity water output (13). Item (14) is the inlet to the membranes and item (15) is the exit of the pure water from the membranes, while at (16) is the exit of the high salinity water from the membranes.

The phases of operation are the following:

The intake pump (2), pumps the salty water through the pre-filter (3) and is then fed to the high pressure pump (5), where the required pressure is reached (about 50 bars) to overcome the osmotic pressure at the semi-permeable membranes (7).

The amount of water that goes through the semi-permeable membranes (about 20-30% of the total) from output (15) of the membranes is sent to output (12) of the unit. The larger part (70%-80%) of the water that enters the unit exits at the output (16) high salinity water of the membranes and before going to output (13) high salinity rejection, it is fed to the high pressure vessels (9) or (20). Initially the vessel (9) is connected to the high pressure circuit via the valve (17). The vessel (20) is filled with salty water from the low pressure circuit via valve (10).

The vessel (9) using valve (19) and with the assistance of the water circulation pump (6), increases the supply of water to the high pressure circuit, without consuming additional energy. When the salinity of the high pressure circuit increases over a pre-defined limit then the following actions are executed:
vessel (20) is connected to the high pressure circuit via (17) and (19)
vessel (9) is disconnected from the high pressure circuit (valves (17) and (19) are closed)
vessel (9) is flushed with salty water from low pressure (valves (10) and (18) are opened)
vessel (9) is filled with salty water from low pressure.

Vessel (20) operates now in the way that vessel (9) did, until the salinity in the high pressure circuit increases over the pre-defined limit. When this occurs the two vessel interchange in the following way:
vessel (9) is connected to the high pressure circuit via (17) and (19)
the vessel (20) is disconnected from the high pressure circuit (valves (17) and (19) are closed)
vessel (20) is flushed with salty water from low pressure (valves (10) and (18) are opened)
vessel (20) is filled with salty water from low pressure.

The proposed method doesn't have loses due to the exchange of the medium as in other energy recovery systems, such as turbines or other pumps, which have efficiency significantly smaller than one. In addition the circulation speed and flow is increased. Due to the high circulation and flow the concentration polarization is reduced. Which means the effect of local increase in the concentration, near the surface of the membrane, is reduced therefore the efficiency of the membrane is improved and the deposits decrease. This invention achieves: (a) the reduction of energy requirements per unit of produced drinking water, (b) has a positive result to the problem of deposits on the membrane and (c) permits the operation of the membrane in conditions of varying water production, which are outside the initial limits and the specifications of the manufacturer. It has higher energy efficiency in comparison to other energy recovery systems, while at the same time is simpler and cheaper to manufacture than the existing systems.

Additional optimizing can be accomplished: a) with the use of a mechanism based on the Bernoulli's Principle under conditions of pressure so as to avoid the use of a high pressure circulator with ultimate goal the reduction of cost and b) by using a centrifugal separator for the removal of the solids and part of the organisms that exist in the water, before entering the membranes, so as to avoid the chemical processing of the water before entering into the membranes and to avoid deposits on the membranes.

1. A method of reduction of deposits on the membranes of reverse osmosis system, which is characterized by brine water recirculation, so that the high salinity concentrated (brine) water coming from the output of the reverse osmosis membranes is redirected at the external surface of the membranes (inlet of the reverse osmosis system), increasing the flow of water around the membranes and thus decreasing the deposits on the membranes.

2. The method according to claim 1 is characterized by the use of: the salty water inlet (1), safety devices (11), low pressure salty water intake pump (2), pre-filter unit (3), high pressure pump (5), reverse osmosis semi-permeable membranes (7), at least two pressure vessels (9), (20), water circulation pump for the high pressure circuit (6), water flow regulation valves (10) , (17), (18), (19), pressure stabilizers (4) and (8), permeate water output (12), high salinity water output (13) and by the existence of at least two pressure vessel that are fed alternately with the high pressure high salinity (concentrate) water coming from the output of the reverse osmosis membranes. The vessels outputs are alternately connected to the high pressure circuit (in the inlet of the reverse osmosis membranes system) and in this way the flow of water to the membranes is increased and reduction of deposits is achieved. The water flow is regulated through: water flow regulation valves, controlling feed volume, recirculation volume, pressure and recovery rate, so that we achieve optimal varying water production and optimal operation when we have a varying power supply. The reverse osmosis salty water (brine) output (which is under high pressure), is fed to one of the two (or more) high pressure vessels which then supplies the inlet of the reverse osmosis membranes through the circulating pump. New water is fed into the reverse osmosis unit with the additional water flow from the high pressure vessel. In this way more water is fed (that is under high pressure) to the membranes without requiring more energy. This also results in more water passing through the membranes (increase of efficiency) and due to the increased flow around membranes, the membrane deposits decrease. The salinity increases gradually in the high pressure circuit. When it becomes high enough then the two pressure vessels are exchanged in the circuit, so that the second (20) operates, while the first (9) is flushed with new input water from the low pressure circuit (using the valves (17)). The possibility to use more pressure vessels enhances the potential of the method.

3. Use of the method of claim 1 in reverse osmosis systems with varying water production, when we have a varying power supply (systems that are powered by renewable energy sources—wind generators and photovoltaic panels—where the power supplied varies and depends on the wind speed or the solar radiation each moment) and so varying water flow and pressure, or when applications require variable water production.

4. Device that operates according to claim 1.

5. Method according to claim 1 which is characterized by the use of Bernoulli inlet orifice in the high pressure circuit instead of a circulation pump.

6. Method according to claim 1 which is characterized by the use of a centrifugal separator for preprocessing of input water.

7. Method according to claim 1 which is characterized by the use of pressure regulating devices (4), (8) to temporarily store energy to smooth rapid variations in power input.

8. Device that operates according to claim 2.

9. Method according to claim 2 which is characterized by the use of Bernoulli inlet orifice in the high pressure circuit instead of a circulation pump.

10. Method according to claim 2 which is characterized by the use of a centrifugal separator for preprocessing of input water.

11. Method according to claim 2 which is characterized by the use of pressure regulating devices (4), (8) to temporarily store energy to smooth rapid variations in power input.
